(19) United States
(12) Patent Application Publication
(10) Pub. No.: US 2005/0015312 A1
(43) Pub. Date: Jan. 20, 2005

(54) Method of selecting and purchasing office furniture

(76) Inventors: Ramona K. Hoffman, Jasper, IN (US); Kevin J. Messmer, Jasper, IN (US)

Correspondence Address: BAKER & DANIELS;111 E. WAYNE STREET, SUITE 800, FORT WAYNE, IN, 46802, US

(21) Appl. No.: 10/872,876

(22) Filed: Jun. 21, 2004

Related U.S. Application Data
(60) Provisional application No. 60/480,873, filed on Jun. 24, 2003.

(51) Int. Cl. G06F 17/60

(52) U.S. Cl. 705/27

(57) ABSTRACT

The present invention involves a method and system for enabling a consumer to select and purchase office furniture at a kiosk located in a retailer store. The method of the present invention includes the steps of enabling a user to submit user information relating to office furniture requirements and user preferences; selecting one or more office furniture components customized to the user based on the user information; and enabling the user to purchase at least one of the customized office furniture components and non-customized office furniture components.

### PRIORITY REFERENCE

This application claims the benefit of priority under 35 U.S.C. § 119(e) to provisional application No. 60/480,873, filed Jun. 24, 2003.

### BACKGROUND OF THE INVENTION

1. Field of the Invention

The present invention generally relates to office furniture and more specifically relates to the selection of office furniture.

2. Description of the Related Art

A small office consumer, e.g., a small business owner or a person furnishing a home office, typically has two sources from which to purchase office furniture: (1) a large retail store, or (2) an independent furniture dealer.

In a large retail store, the small office consumer is confronted with a large, open display area of various desks, chairs, or other office furniture components made by different manufacturers from which the consumer may choose. In many instances, the retail store's employees do not have detailed knowledge regarding all of the different manufacturers' office furniture components carried by the retail store. For this reason, the retail store employees may not be very helpful to the consumer seeking to obtain specific information during her selection of office furniture components. The consumer is thus forced to select office furniture components on her own without help from the retailer.

When the consumer finally selects office furniture, the delivery, installation, and service capabilities of the retail store are often limited. Because the retail store's deliverers and installers are forced to learn general information regarding a number of manufacturers' office furniture components, they are not always able to provide the most efficient means of delivery and installation when it comes to a specific manufacturer's product. Installation time is therefore increased for manufacturer-specific office furniture components, and the ability of the retail store to provide effective service decreases when issues arise requiring specific knowledge of a manufacturer's office furniture component.

The consumer does have an alternative to purchasing furniture from the large retail store. The consumer may visit an independent dealer who is able to provide office furniture design and selection input in person. In utilizing this avenue, the consumer may personally meet with a designer and look through various catalogs, swatch books, etc., of office furniture products, as well as fabric and color examples, to choose a particular configuration of office furniture to suit the consumer's needs. Due to its specialized nature, however, this office furniture selection process is often time consuming and expensive.

### SUMMARY OF THE INVENTION

The present invention provides the small office consumer with a time efficient and inexpensive method of selecting and ordering office furniture components which customizes the configuration of components for the consumer's needs. In one embodiment of the present invention, the method includes the steps of enabling a user to submit user information relating to office furniture requirements and user preferences; selecting one or more office furniture components customized to the user based on the user information; and enabling the user to purchase at least one of the customized office furniture components and non-customized office furniture components.

In another embodiment of the present invention, includes the steps of determining the user's work style based on information submitted by the user; utilizing the user's work style to select one or more office furniture components customized to the user; and enabling the user to purchase at least one of the customized office furniture components and non-customized office furniture components.

In yet another embodiment of the present invention, a system for selecting and ordering the office furniture components is provided, the system including a computer enabling a user to input user information relating to office furniture requirements and the user's preferences; and a server accessible by the computer over a network, the server storing software capable of performing the steps of determining the user's work style based on the inputted user information; selecting one or more office furniture components customized to the user based on the user's work style; and enabling the user to purchase the one or more office furniture components customized to the user.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is schematic view of the architecture of the present invention.

FIG. 2 is a diagrammatic view of the functionality of the Main Menu user interface of the software of the present invention.

FIG. 3 is a diagrammatic view of the functionality of the Choose Individual Item link of the main menu of FIG. 2.

FIG. 4 is a diagrammatic view of the functionality of the Choose Based on Work Style link of the main menu of FIG. 2.

FIG. 5 is a diagrammatic view of the functionality of the Choose Based on Budget link of the main menu of FIG. 2.

FIG. 6 is a diagrammatic view of the functionality of the Optimal Use of Existing Office Space link of the main menu of FIG. 2.

FIG. 7 is a diagrammatic view of the functionality of the Accommodating Additional Employee link of the main menu of FIG. 2.

FIG. 8 is a diagrammatic view of the functionality of the Moving or Remodeling Office link of the main menu of FIG. 2.

FIG. 9 is a diagrammatic view of the functionality of the Changing the Look of the Office link of the main menu of FIG. 2.

FIG. 10 is a diagrammatic view of the functionality of the Office Planning and Designing Tool link of the main menu of FIG. 2.

FIG. 11 is a diagrammatic view of the functionality of the Contact Us link of the main menu of FIG. 2.

FIG. 12 is a diagrammatic view of the functionality of the My Stingray link of the main menu of FIG. 2.

FIG. 13 is a diagrammatic view of the functionality of the Selecting Music Preference link of the main menu of FIG. 2.

FIG. 14 is a diagrammatic view of the functionality of the Immediate Assistance link of the main menu of FIG. 2.

FIG. 15 is a diagrammatic view of the functionality of the Help link of the main menu of FIG. 2.

FIG. 16 is a diagrammatic view of the functionality of the Exit link of the main menu of FIG. 2.

FIG. 17 is a diagrammatic view of the functionality of the View Product Details link displayed in FIGS. 3, 4, 5, 6, 7, 8, 9 and 25.

FIG. 18 is a diagrammatic view of the functionality of the Choose Colors link displayed in FIGS. 3, 4, 5, 6, 7, 8, 9, 17 and 25.

FIG. 19 is a diagrammatic view of the functionality of the Print/Email link displayed in FIGS. 3, 4, 5, 6, 7, 8, 9, 17, 22, 25 and 26.

FIG. 20 is a diagrammatic view of the functionality of the Save Layout link displayed in FIGS. 3, 4, 5, 6, 7, 8, 9 and 17.

FIG. 21 is a diagrammatic view of the functionality of the Add to Wish List link displayed in FIGS. 3, 4, 5, 6, 7, 8, 9, 12, 17, 22 and 25.

FIG. 22 is a diagrammatic view of the functionality of the Buy link displayed in FIGS. 3, 4, 5, 6, 7, 8, 9, 17 and 25.

FIG. 23 is a diagrammatic view of the functionality of the Slide Show link displayed in FIGS. 3, 4, 5, 6, 7, 8, 9, 17, 20 and 25.

FIG. 24 is a diagrammatic view of the functionality of the Login link displayed in FIG. 12.

FIG. 25 is a diagrammatic view of the functionality of the View Saved Layouts link displayed in FIG. 12.

FIG. 26 is a diagrammatic view of the functionality of the Track Placed Order link displayed in FIG. 12.

FIG. 27 is a schematic view of the connectivity between the consumer's system and the design specialist with whom the present invention enables the consumer to communicate.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates embodiments of the invention, in several forms, and such exemplifications are not to be construed as limiting the scope of the invention in any manner.

### DESCRIPTION OF THE INVENTION

The embodiments disclosed below are not intended to be exhaustive or limit the invention to the precise forms disclosed in the following detailed description. Rather, the embodiments are chosen and described so that others skilled in the art may utilize their teachings.

The detailed descriptions which follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system may be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which may be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks may access the network resources, such as shared data files, common peripheral devices, and inter-workstation communication. Users activate computer programs or network resources to create “processes” which include both the general operation of the computer program along with specific operating characteristics determined by input variables and its environment. The term “network” also relates to a communications network, i.e., a medium that allows communications data to flow between multiple, connected systems. For instance, one type of communications network may be a globally accessible information interchange that includes the Internet. In this type of global network, millions of computer systems are connected and data is transmitted over the network between multiple computer systems.

The terms “desktop”, “personal desktop facility”, and “PDF” mean a specific user interface which presents a menu or display of objects with associated settings for the user associated with the desktop, personal desktop facility, or PDF. When the PDF accesses a network resource, which typically requires an application program to execute on the remote server, the PDF calls an Application Program Interface, or “API”, to allow the user to provide commands to the network resource and observe any output. The term “Browser” refers to a program which is not necessarily apparent to the user, but which is responsible for transmitting messages between the PDF and the network server and for displaying and interacting with the network user. Browsers are designed to utilize a communications protocol for transmission of text and graphic information over a world wide network of computers, namely the “World Wide Web” or simply the “Web.” Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

A location on the World Wide Web is known as a web site. On electronic commerce web sites, or those web sites on which online business may be conducted, “shopping carts”, “shopping lists”, and “wish lists” are often utilized. A shopping cart is an object that generally provides the functionality of an online ordering process. The shopping cart enables consumers to store information relating to merchandise available on the web site in an accessible location, review what they have selected, make necessary modifications or additions to their selections, and purchase the merchandise by reference to the shopping cart object. A shopping list is another object that typically functions similar to a shopping cart except that it does not typically facilitate the purchasing of the selected merchandise, rather the shopping list simply identifies items to be potentially purchased. A wish list is an object that enables a consumer to select merchandise and add it to an online list, typically for the purpose of indicating to others which items the originator of the wish list would desire to either have purchased for them, or for later purchase. Additions and modifications may be made to the wish list by the consumer, and the consumer may make the wish list available to others so that they may view and/or purchase the selected items as a gift for the consumer who originated the list.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The term “customize(d)” used in reference to furniture hereinafter means to design furniture based on a user's (i.e., a user of a software application) or a consumer's specifications, e.g., color, finish, fabrics, etc.

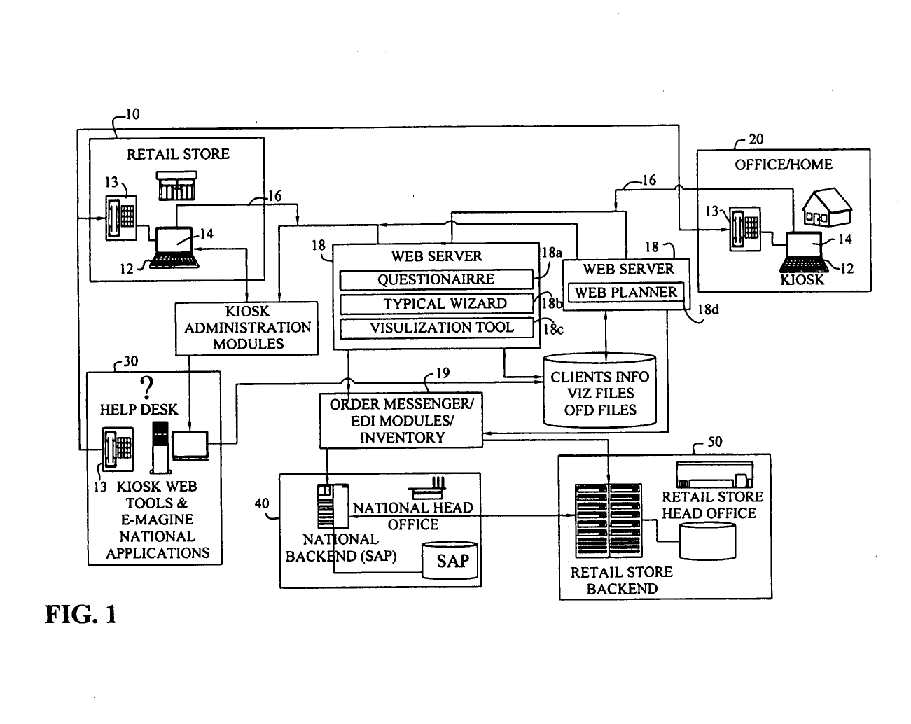

The present invention provides a system for and a method of selecting and purchasing office furniture. FIG. 1 shows the architecture of a computer system in which the method of the present invention may be implemented. An office furniture manufacturer provides retail store 10 with computer 12. Computer 12 includes a keyboard, mouse and display 14 that provides a user interface with which the computer 12 user may interact. Computer 12 may be provided as part of a kiosk that includes a credit card machine (not shown) that enables users to pay for the manufacturer's office furniture, speakers (not shown), standalone or networked printers (not shown), a video web camera (not shown) with web-enabled microphones (not shown) and telecommunications equipment represented by telephone 13. Other known telecommunications devices may be used with the present invention. A select display of the office manufacturer's furniture may also be placed near the kiosk so that the user of computer 12 may see, feel, and inspect the quality of the office manufacturer's furniture. Computer 12 is controlled by an application stored in computer 12 memory.

Computer 12 is in communication with web server 18 via network 16. In an exemplary embodiment, network 16 may be the Internet. Computer 12 may achieve connection with network 16 by known connection means, including, but not limited to, a dial-up modem, cable modem, or digital subscriber line (“DSL”). The user interface of computer 12 may be implemented as a web site or include web browser capabilities, e.g., enabling computer 12 user to access network 16. Web server 18 stores multiple applications accessible to computer 12, including, but not limited to, questionnaire application 18a, wizard application 18b, visualization tool application 18c and web planner application 18d. Web server 18 may also store client information in the form of VIZ or OFD files when the user decides to save her furniture design and/or selection.

Computer 12 may also be used within an office/home environment 20. Office/home environment 20 includes telephone 13, and computer 12 is in communication with web server 18 over network 16.

If the user of computer 12 encounters difficulty in selecting and ordering office furniture, the user may indicate such via the user interface and an employee located at furniture manufacturer helpdesk 30 may call the user and walk her through the problem. The user may also be provided with 1) a toll-free phone number that the user may use to call helpdesk 30; 2) help over the web-enabled microphones; and/or 3) on-line chat help. The video web camera may be used in this instance for the user to view the helpdesk employee helping her with the problem. The helpdesk employee may also request that the user send her furniture design to helpdesk 30 over network 16 so that the employee can review the file in determining where an problem may have arisen.

When the user of computer 12 has selected the office furniture in accordance with her needs, modules 19 are invoked to provide communication between the user and either the furniture manufacturer's furniture source 40 and/or the retailer's supply source 50 to verify the order, determine furniture availability, provide acknowledgement to the user, instruct the user on where/how to track her order, provide the user with ability to add to/cancel the order, etc.

The method of the present invention will now be described by describing the steps a consumer of retail store 10 may go through in carrying out the method.

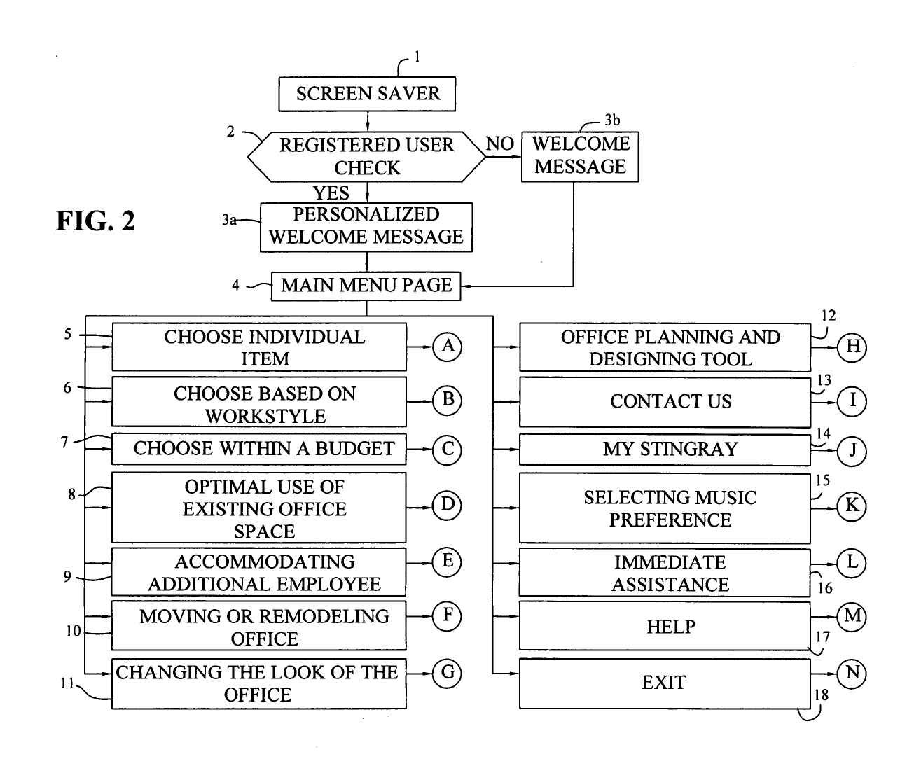

A furniture manufacturer may provide computer 12 in a kiosk in retail store 10. Computer 12 includes memory for storing the software of the present invention, the software enabling the user of computer 12 to select, design, order and purchase the furniture manufacturer's furniture. A consumer of retail store 10 may approach the kiosk containing computer 12. Display 14 of computer 12 of the exemplary embodiment contains a touch-driven user interface, and the functionality of the user interface is shown in FIG. 2. The user interface is capable of displaying Screen Saver 1 as the consumer approaches computer 12, and Screen Saver 1 may include the office furniture manufacturer's logo, a video of the office furniture manufacture's available furniture, image renderings of individual furniture pieces, open offices and walled offices, and/or a simulation of an office being designed using the software. Upon clicking on computer's 12 keyboard or touching the user interface on display 14 or otherwise activating the software, the software determines at Registered User Check 2 whether the consumer is a registered user. If not, the consumer is presented with Welcome Message 3 and then Main Menu 4. If the consumer has previously registered, he is presented with Personalized Welcome Message 3 and then Main Menu 4. Personalized/Welcome Message 3 may include a voice and/or an image describing the number of steps and the time it takes to complete the consumer's furniture design.

Referring to FIG. 2, Main Menu 4 is the consumer's primary point-of-access to the features provided by the software of the present invention. Main Menu 4 presents the consumer with fourteen (14) options, i.e., Choose Individual Item link 5, Choose Based on Work Style link 6, Choose within a Budget link 7, Optimal Use of Existing Office Space link 8, Accommodating Additional Employee link 9, Moving or Remodeling Office link 10, Changing the Look of the Office link 11, Office Planning and Designing Tool link 12, Contact Us link 13, My Stingray link 14, Selecting Music Preference link 15, Immediate Assistance link 16, Help link 17 and Exit link 18. Each link supports several features required to purchase furniture such as selection, customization, personalization, etc. The consumer may activate the links by touching the links or hovering computer's 12 mouse over the links.

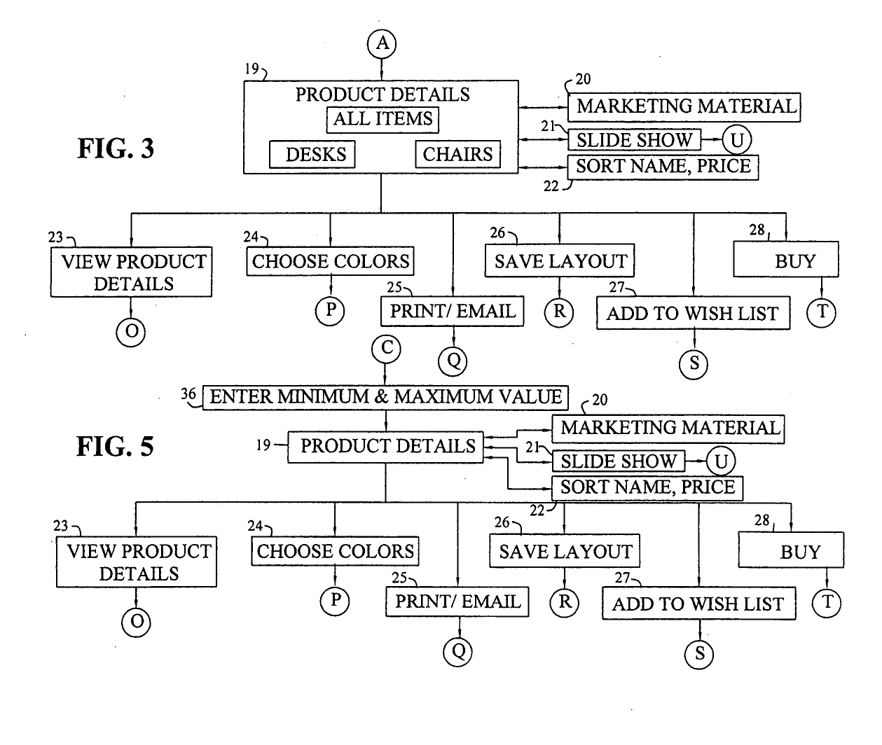

Choose Individual Item link 5 on Main Menu 4 (FIG. 3) enables the user to purchase individual furniture items. As shown in FIG. 3, upon selecting Choose Individual Item link 5, the software presents the user with Product Details page 19 containing Marketing Material feature 20, Slide Show feature 21, Characteristic Sort feature 22, View Product Details feature 23, Choose Colors feature 24, Print/Email feature 25, Save Layout feature 26, Add to Wish List feature 27 and Buy feature 28. By default, all the furniture items with a brief item description and price are displayed on the page. The consumer may choose to have a selective view of chairs or desks by utilizing feature 19, and feature 20 enables the consumer to view the marketing material for the particular furniture type. Feature 21 enables the consumer to view the associated slide show for the furniture and select a furniture item. If desired, the consumer may exit midway through the slide show without making a selection.

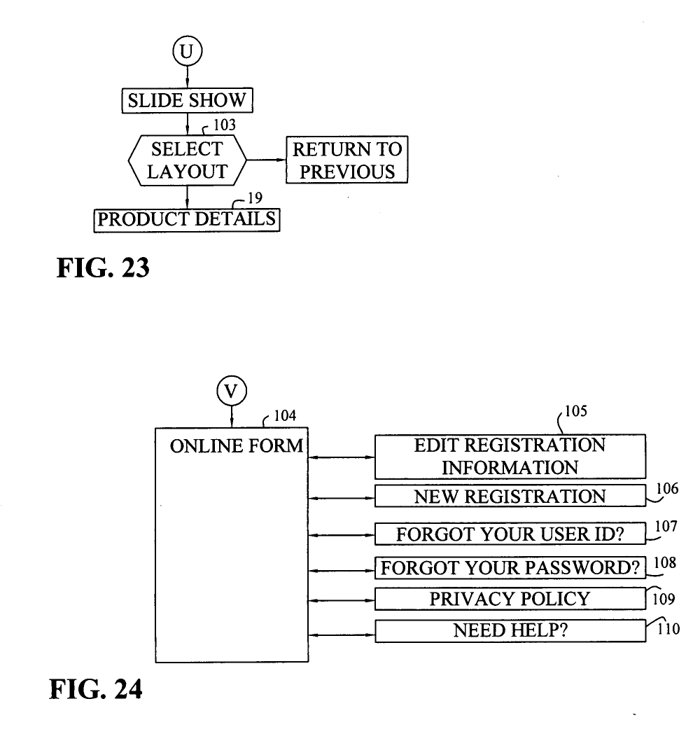

Upon selecting Slide Show feature 21, as shown in FIG. 23, the consumer may view a slide show displaying furniture, and the consumer may select any of the displayed furniture at 103. The consumer may also close the slide show and return to the previous page without making any selection.

Sort feature 22 of FIG. 3 enables the consumer to sort the displayed furniture to view items based on furniture characteristics, such as name, style, type or price.

View Product Details link 23 of FIG. 3 enables the consumer to view the detailed design specifications, namely the product image, details, description, and dimensions. As shown in FIG. 17, upon selecting link 23, the consumer is presented with Detailed Product View page 63 containing Design Check List feature 64, View Product Testing feature 65, View Retail Store Map feature 66 and other features that will be discussed supra. Page 63 enables the consumer to view the detailed product view, and Design Check List feature 64 enables the consumer to view the design checklist. The consumer may also utilize View Product Testing feature 65 to view a slide show demonstrating the sturdiness of the furniture. A retail store map is available to the consumer by using View Retail Store Map feature 66, and the retail store map provides a map to guide the consumer to where the particular furniture item is located in retail store 10 (FIG. 1). The consumer may customize the furniture using visualization tool application 18c (e.g., change the finishes and fabrics), as well as email and print the shopping list, floor plan, picture and the design checklist. The selected item may be saved or added to the wish list and shopping cart.

Choose Colors link 24 of FIG. 3 enables the consumer to customize the furniture. As shown in FIG. 18, upon selecting link 24, the consumer is presented at Viz Tool 67 (FIG. 18) with visualization tool application 18c to customize the selected furniture.

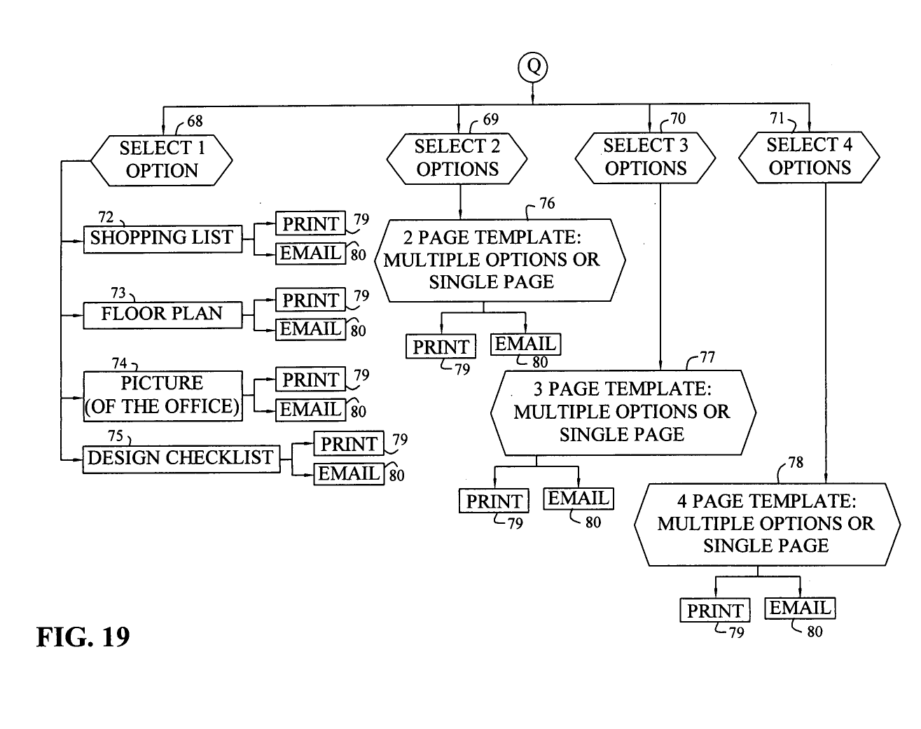

Print/Email link 25 of FIG. 3 enables the consumer to print or email the shopping list, floor plan, picture and the design checklist. Each information item may be printed on a single page or on separate pages. As shown in FIG. 19, upon selecting link 25, the consumer is presented with Select options 68, 69, 70, 71. Select 1 Option option 68 enables the consumer to select any one of the following features: shopping list 72, floor plan 73, picture (of the consumer's office) 74, or design checklist 75. Select 2 Options option 69 enables the consumer to select any two of the above-named features, Select 3 Options option 70 enables the consumer to select any three of the above-named features and Select 4 Options option 71 enables the consumer to select all the above-named features.

Shopping List feature 72 enables the consumer to select a shopping list. Floor Plan feature 73 enables the consumer to select a floor plan. Picture Feature 74 enables the consumer to select a picture of the consumer's office. Design Checklist feature 75 enables the consumer to select a design checklist. A design checklist is a list used by the consumer to ensure that the specifications of the office furniture components are compatible with the design of the location in which the components will be placed. For example, the design checklist may include the location of phone jacks, whether the walls are load bearing, room measurements, ceiling height, etc. Template feature 76 enables the consumer to print or email the selected two options on a single page or single item per page. Template feature 77 enables the consumer to print or email the selected three options on a single page or single item per page, and Template feature 78 enables the consumer to print or email the selected four options on a single page or single item per page. Print and Email features 79 and 80, respectively, which are accessible from features 72, 73, 74, 75, 76, 77, 78, enable the consumer to print and email a selected item.

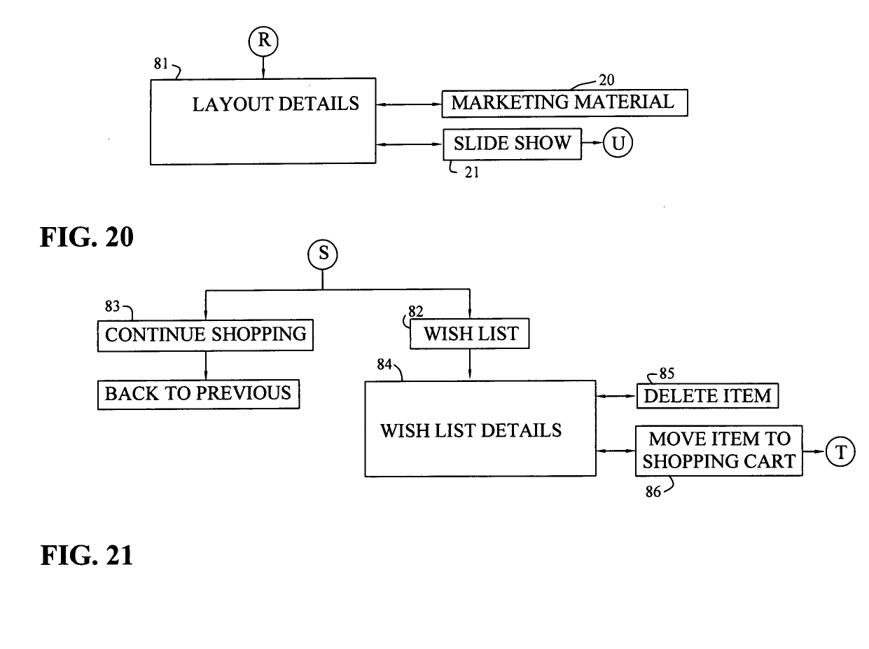

Save Layout feature 26 of FIG. 3 enables the consumer to choose to save the selected layout after specifying a name and a description. The saved layout is then available to the consumer for future reference. As shown in FIG. 20, selecting feature 26 enables the consumer to save the selected furniture at Layout Details feature 81 by providing a name and a description. Additionally, Marketing Material feature 20 and Slide Show feature 21 are available to the consumer from this page as well.

Add to Wish List link 27 of FIG. 3 enables the consumer to add the selected furniture items to a wish list, which the consumer may save and later retrieve. As shown in FIG. 21, upon selecting link 27, the consumer is presented with a confirmation message regarding furniture added to the wish list 82, and the consumer may use Continue Shopping feature 83 to continue shopping. The consumer may view the wish list details at Wish List Details page 84, delete items from the wish list using Delete Item feature 85, and move items to the shopping cart at Move Items to Shopping Cart feature 86.

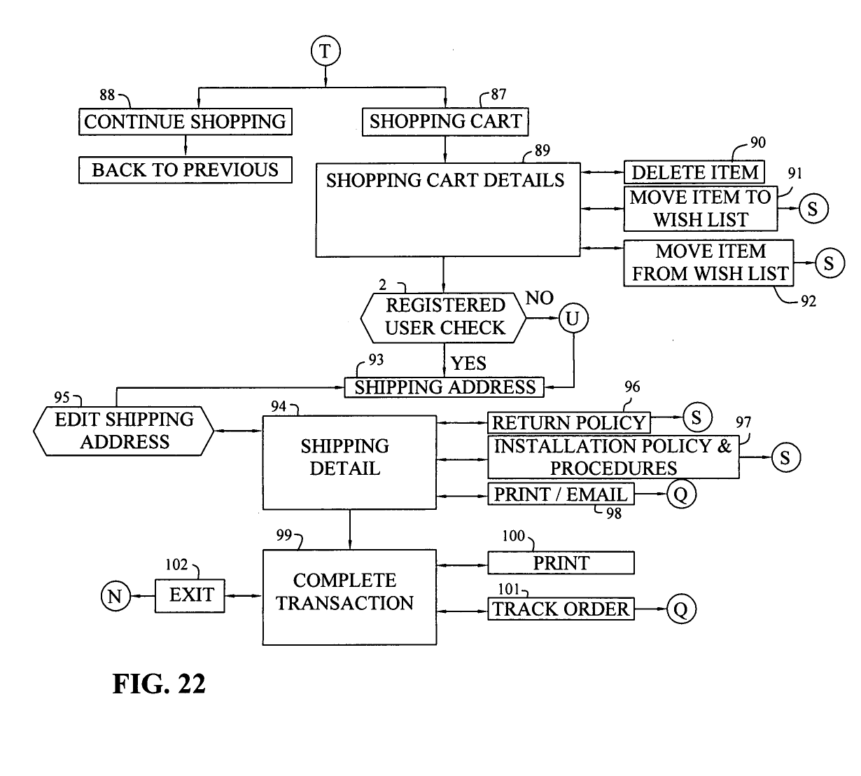

Buy link 28 of FIG. 3 enables the consumer to directly add the furniture to the shopping cart. As shown in FIG. 22, upon adding an item to the shopping cart, the consumer views a confirmation message at Shopping Cart feature 87. Continue Shopping feature 88 enables the consumer to continue to do the shopping, or the consumer may utilize Shopping Cart Details feature 89 to view the shopping cart details. Delete Item feature 90 enables to the consumer to delete items from the shopping cart, Move Item to Wish List feature 91 enables the consumer to move items to the wish list, and Move Item from Wish List feature 92 enables the consumer to move items from the wish list. The consumer may also proceed to buy the items by using Shipping Address feature 93 to enter shipping address details. The consumer may pay by using his credit card at the kiosk or online, by paying cash at retailer 10 cashier, by being invoiced, or by opening up an account for financing. Such an account may be opened with either retail store 10 or the office furniture manufacturer. Shipping detail feature 94 enables the consumer to view the complete shipping details, and Edit Shipping Address feature 95 enables the consumer to edit the shipping details, if required. If the consumer has not logged in or registered with the software, he is asked to do so. The consumer may use Return Policy feature 96 to access the return policy, and Installation Policy & Procedures feature 97 enables the consumer to access the installation policy and procedures. The consumer may also print and email the shipment details by using Print/Email feature 98. Complete Transaction feature 99 indicates that the consumer has completed the transaction. The consumer may print the transaction details using Print feature 100, and Track Order feature 101 enables the consumer to track the placed order. Exit feature 102 enables the consumer to exit from the system.

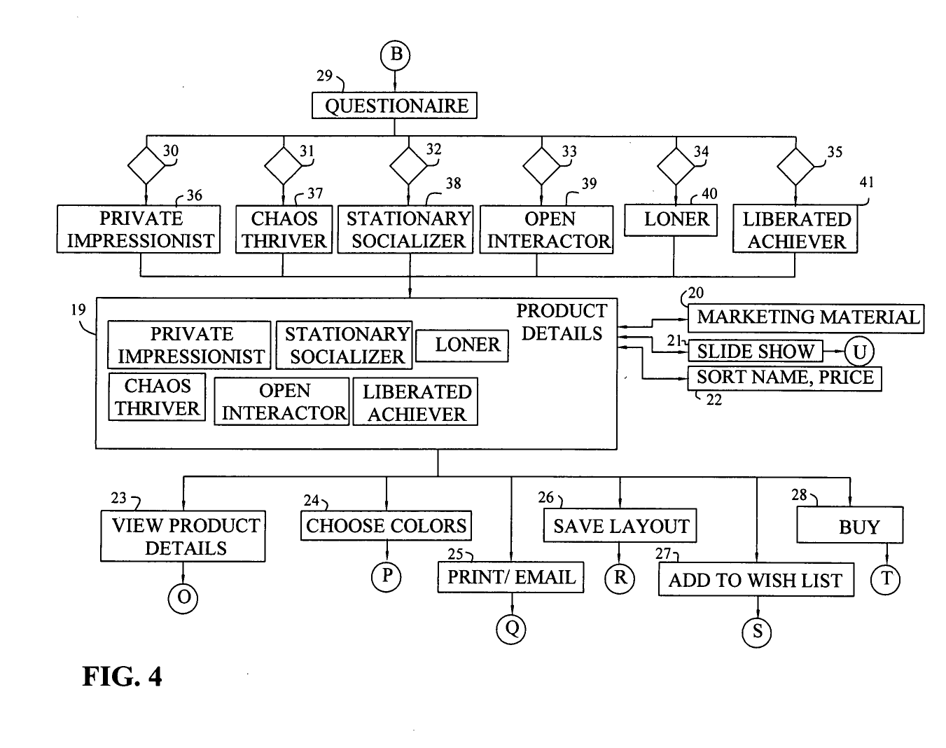

Choose Based on Work Style link 6 on Main Menu 4 (FIG. 2) enables the consumer to purchase furniture based on “work style.” “Work style” is hereinafter defined as the type of office solution that best fits the consumer's attitudes and beliefs with regard to work management, work environment, and emotional well being. The “work styles” may be derived based on market segmentation studies conducted by the office furniture manufacturer. As shown in FIG. 4, upon selecting this link from the main page, the consumer is provided with a questionnaire at 29 to determine the consumer's work style. The consumer is instructed to choose the most appropriate answer for each of the questions provided in the questionnaire, and all of the twenty (20) questions are relevant to the determination of work style. After the consumer answers the questions, the software determines, based on the questionnaire score, the consumer's work style. Based on the segmentation study conducted by the office manufacturer, a consumer may be categorized into one of seven (7) potential segments. A variety of known questionnaire methods may be used to generate a numeric expression of the consumer's work style.

If the software classifies the consumer as a “Private Impressionist”, the consumer may exhibit the following characteristics: 1) the consumer believes that furniture absolutely matters; 2) the consumer believes that privacy is a must; 3) the consumer believes that organization helps productivity; 4) the consumer believes that technology is not a problem; and 5) the consumer is positive about her life and job. The consumer may view the characteristics of the Private Impressionist work style at 36. If the software classifies the consumer as a “Chaos Thriver”, the consumer may exhibit the following characteristics: 1) the consumer works best with piles and clutter; and 2) the consumer is not intimidated by constantly changing technology. The consumer may view the characteristics of the Chaos Thriver work style at 37. If the software classifies the consumer as a “Stationary Socializer”, the consumer may exhibit the following characteristics: 1) the consumer likes routine and feels a great deal of loyalty to her employer; 2) the consumer believes that technology makes life more difficult; 3) the consumer believes that it is important for the consumer to interact with others; 4) the consumer tends to have been in her job longer than consumers classified in the other named categories; and 5) the consumer is happy with her life. The consumer may view the characteristics of the Stationary Socializer work style at 38. If the software classifies the consumer as an “Open Interactor”, the consumer may exhibit the following characteristics: 1) the consumer believes that she controls her own destiny and considers change to be good; 2) the consumer is not intimidated by constantly changing technology; 3) the consumer is concerned about the furniture in her workplace; and 4) the consumer is a positive person. The consumer may view the characteristics of the Open Interactor work style at 39. If the software classifies the consumer as a “Loner”, the consumer may exhibit the following characteristics: 1) the consumer does not feel good about her life; 2) the consumer does not feel loyalty towards her employer; 3) the consumer does not believe that employers care about their employees; 4) the consumer dislikes change; 5) the consumer is bothered by working in noisy and open areas; 6) the consumer wishes that her office could be at her home; and 7) the consumer believes that furniture is important to her productivity. The consumer may view the characteristics of the Loner work style at 40. If the software classifies the consumer as a “Liberated Achiever”, the consumer exhibits the following characteristics: 1) the consumer does not believe that office furniture matters; 2) the consumer feels good about her life; 3) the consumer feels that organization is important; 4) the consumer believes the personalizing office space is not important; and 5) the consumer is not influenced by the appearance of her office. The consumer may view the characteristics of the Liberated Achiever work style at 41. The software may also determine other classifications based on different market studies that may be conducted by the office furniture manufacturer. In addition to these features, other features are available to the consumer as well, including Product Details feature 19, Marketing Material feature 20, Slide Show feature 21, Characteristic Sort feature 22, View Product Details feature 23, Choose Colors feature 24, Print/Email feature 25, Save Layout feature 26, Add to Wish List feature 27 and Buy feature 28.

Choose within a Budget link 7 on Main Menu 4 (FIG. 2) enables the consumer to purchase furniture based on a budget. A “budget” refers to a dollar range indicating the amount of money which the consumer is willing to spend on office furniture. As shown in FIG. 5, upon selecting this link from the main page, Enter Minimum & Maximum feature 36 prompts the consumer to provide a minimum and a maximum monetary value to enable the software to display all of the furniture items which prices fall within the consumer's specified range. Other features are also available to the consumer, including Product Details feature 19, Marketing Material feature 20, Slide Show feature 21, Characteristic Sort feature 22, View Product Details feature 23, Choose Colors feature 24, Print/Email feature 25, Save Layout feature 26, Add to Wish List feature 27 and Buy feature 28.

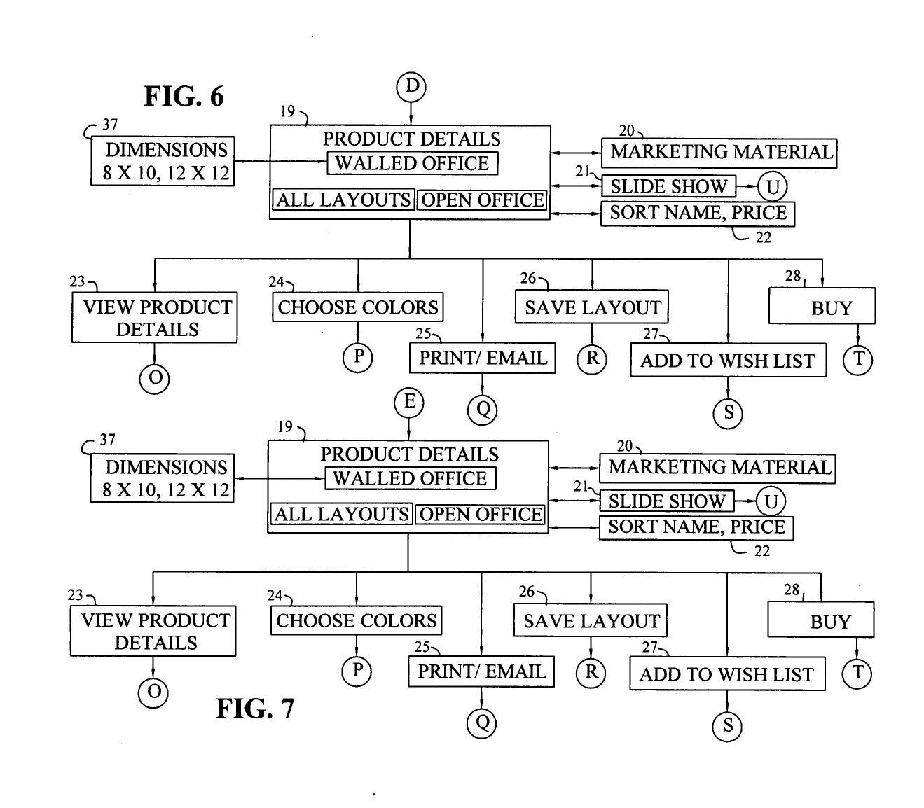

Optimal Use of Existing Office Space link 8 of Main Menu 4 (FIG. 2) enables the consumer to consider optimal usage of his existing office space while purchasing furniture. As shown in FIG. 6, upon selecting this link, Product Details 19 enables the user interface to display walled layouts for which the consumer may specify the dimensions using Dimensions feature 37. Feature 37 enables the consumer to choose to have a selective view of open office layouts or all layouts. In addition to these features, Marketing Material feature 20, Slide Show feature 21, Characteristic Sort feature 22, View Product Details feature 23, Choose Colors feature 24, Print/Email feature 25, Save Layout feature 26, Add to Wish List feature 27 and Buy feature 28 are available to the consumer as well.

Accommodating Additional Employee link 9 of Main Menu 4 (FIG. 2) enables the consumer to add-on additional furniture pieces compatible with previous purchases if new employees have been hired. After choosing link 9, the software of the present invention retrieves and displays the layout(s) of the consumer's previous purchase(s) so that the consumer can view in the same layout(s) add-on furniture pieces to potentially be purchased by the consumer. The software also may analyze the consumer's past purchases and make recommendations of furniture pieces that compliment the consumer's past buying practices. As shown in FIG. 7, upon selecting link 9, Product Details feature 19 allows the consumer to view walled offices by default. Feature 37 enables the consumer to choose to have a selective view of open office layouts or all layouts. Features also available to the consumer include Marketing Material feature 20, Slide Show feature 21, Characteristic Sort feature 22, View Product Details feature 23, Choose Colors feature 24, Print/Email feature 25, Save Layout feature 26, Add to Wish List feature 27 and Buy feature 28.

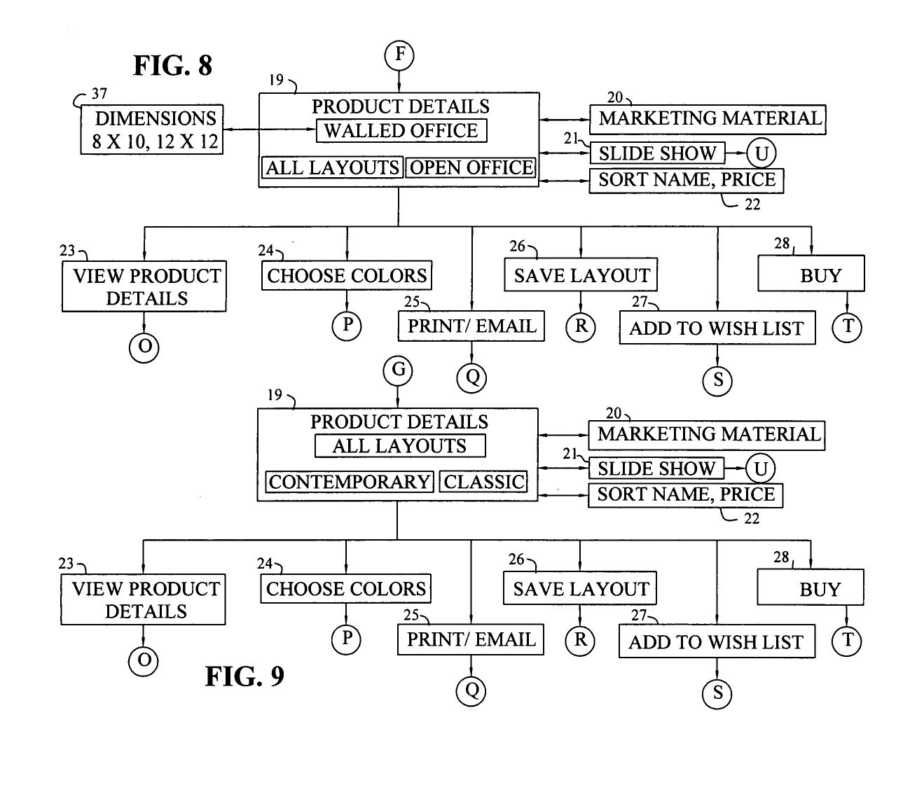

Moving or Remodeling Office link 10 of Main Menu 4 (FIG. 2) enables the consumer to purchase furniture for an office that is to be moved or remodeled. As shown in FIG. 8, upon selecting this link, the consumer is able to use feature 19 to view walled offices by default. For the walled office, an additional facility of specifying the dimensions is available at the consumer by using feature 37. For example, if the consumer knows the office space dimensions of the office in which the consumer will be moving, this feature of the software provides the consumer with a selection of walled office layouts that fit the office space dimensions in which the consumer will be constrained. Similarly, if the consumer knows that in remodeling his office he will be limited to a certain amount of space, this feature enables the consumer to choose from a selection of office layouts designed to furnish the consumer's limited space. Moving or Remodeling Office link 10 also enables the consumer to personalize the office space at which he is looking by allowing the consumer to select wall, ceiling and floor textures and/or finishes to understand how the furniture he is considering will look in the office space. If the consumer does not like the desired look, Product Details feature 19 enables him to either change the finishes and/or fabric on the furniture he is reviewing or change the textures and/or finishes on the walls, ceilings and flooring within the rendering scheme. Additional features available to the consumer include Marketing Material feature 20, Slide Show feature 21, Characteristic Sort feature 22, View Product Details feature 23, Choose Colors feature 24, Print/Email feature 25, Save Layout feature 26, Add to Wish List feature 27 and Buy feature 28.

Changing the Look of the Office link 11 of Main Menu 4 (FIG. 2) enables the consumer to change the layout of an office. As shown in FIG. 9, upon selecting this link, the consumer is able to view, by default, all layouts using Product Details feature 19. Feature 19 also enables the consumer to selectively view new offices with contemporary or classic layouts. This feature further enables the consumer to search for and select individual furniture components to place in existing offices. In addition to these features, other features available to the consumer include Marketing Material feature 20, Slide Show feature 21, Characteristic Sort feature 22, View Product Details feature 23, Choose Colors feature 24, Print/Email feature 25, Save Layout feature 26, Add to Wish List feature 27 and Buy feature 28.

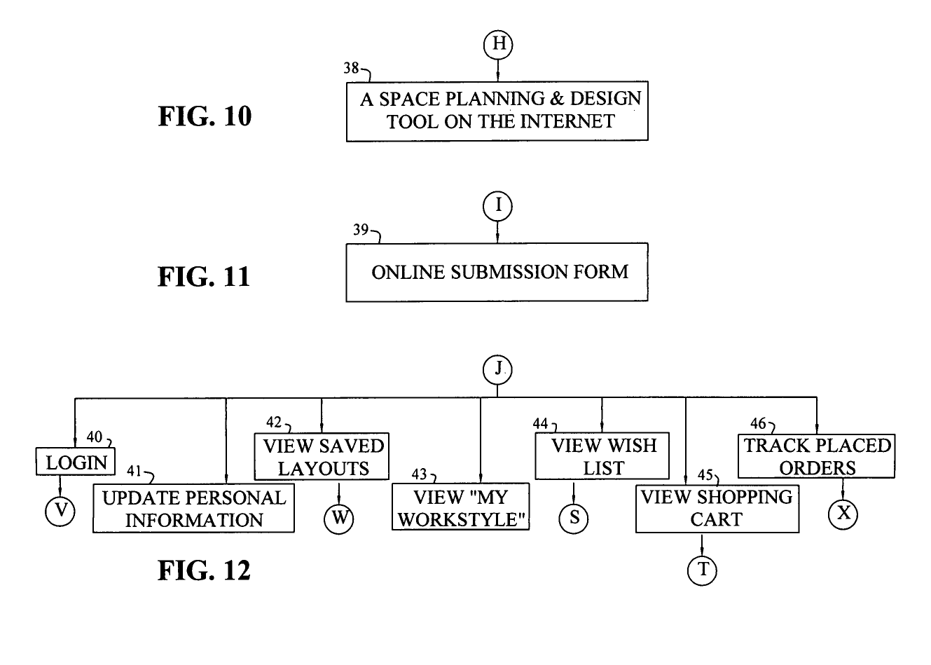

Office Planning and Design Tool link 12 of Main Menu 4 (FIG. 2) enables the consumer to plan and design furniture on the Internet. As shown in FIG. 10, upon selecting this link, the consumer accesses at Space Planning and Design Tool feature 38.

Contact Us link 13 of Main Menu 4 (FIG. 2) provides an online form which the consumer may fill-in if any additional information is required. As shown in FIG. 11, upon selecting Contact Us link 13, the consumer is provided with Online Submission form 39 in which the consumer may enter personal and query details for submission.

My Stingray link 14 of Main Menu 4 (FIG. 2) provides the consumer with the facility to access and update personalized information. As shown in FIG. 12, upon selecting My Stingray link 14, the consumer is presented with Login feature 40, Update Personal Information feature 41, View Save Layouts feature 42, View “My Workstyle” feature 43, View Wish List feature 44, View Shopping Cart feature 45 and Track Placed Orders 46.

The consumer may utilize Login feature 14 to log into the software. Shown in FIG. 24, the consumer may utilize Online Form 104 to log into the software by using the consumer's user id and password. The consumer may edit the registration information provided earlier using Edit Registration Information feature 105, enter details to register with the software by using New Registration feature 106, retrieve a forgotten user id using Forgot Your User ID feature 107, retrieve a forgotten password using Forgot Your Password feature 108, view the privacy policy using Privacy Policy feature 109 and access help using Need Help feature 110.

Update Personal Information feature 41 of FIG. 11 enables the consumer to update personal registration details.

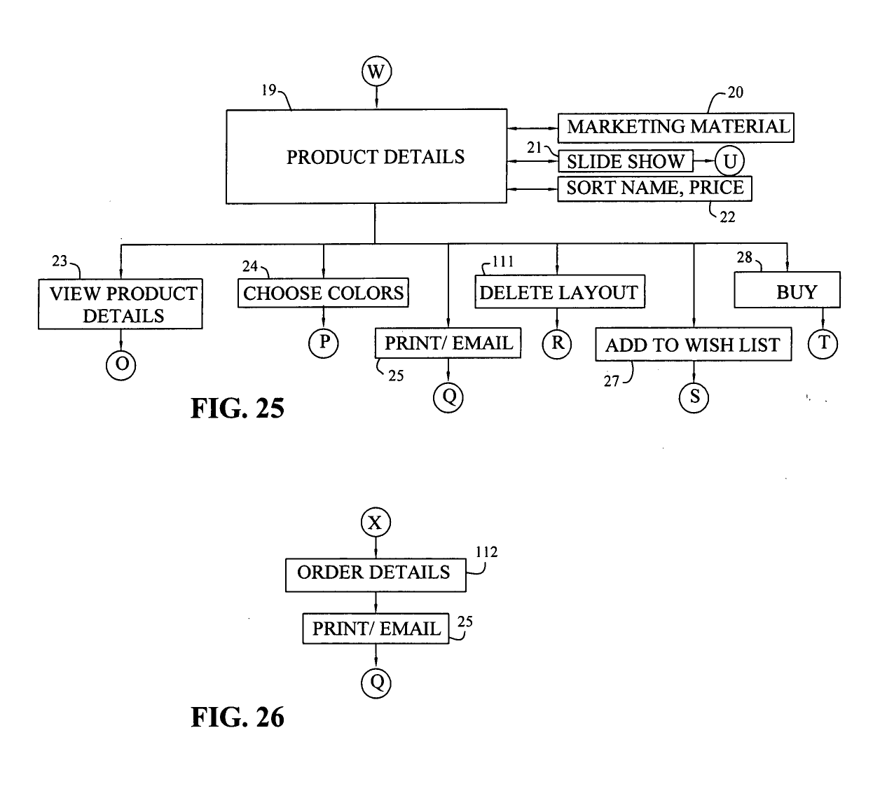

View Saved Layouts feature 42 of FIG. 11 enables the consumer to view layouts the consumer has saved. Shown in FIG. 25, upon selecting View Save Layouts feature 42, the consumer may use Product Details feature 19 to view any layouts earlier saved by the consumer. The consumer may also delete any layout from the saved layout list by using Delete Layout feature 111. Additional features available to the consumer include Marketing Material feature 20, Slide Show feature 21, Characteristic Sort feature 22, View Product Details feature 23, Choose Colors feature 24, Print/Email feature 25, Add to Wish List feature 27 and Buy feature 28.

View “My Workstyle” feature 43 of FIG. 11 enables the consumer to view the consumer's type of work style, which has been derived based on the questionnaire earlier submitted by the consumer. The consumer may also use Feature 43 to view the furniture suitable for the consumer's work style.

View Wish List feature 44 of FIG. 11 enables the consumer to view a saved wish list, as described supra regarding FIG. 21.

View Shopping Cart feature 45 of FIG. 11 enables the consumer to view the saved shopping cart. As shown in FIG. 22, upon selecting View Shopping Cart feature 45, the consumer views a displayed confirmation message by using Shopping Cart feature 87. The consumer may then continue shopping using feature 88, view the shopping cart details by using feature 89, delete an item from the shopping cart by using feature 90, move an item to the wish list by using feature 91 or remove an item from the wish list by using feature 92. The consumer may also utilize Shipping Address feature 93 to enter shipping address details, view the complete shipping details by using feature 94, edit the shipping details by using feature 95, access the return policy by using feature 96, access the installation policy and procedures by using feature 97 and print and email shipment details by using feature 98. Complete Transaction feature 99 indicates that the consumer has completed the transaction, and the consumer may use Print feature 100 to print the transaction details. The consumer may also use feature 101 to track the placed order use Exit feature to exit from the system.

Track Placed Orders feature 46 of FIG. 11 enables the consumer to view the status and other furniture details such as description, price, and quantity of all the placed orders. Shown in FIG. 26, upon selecting Track Place Orders feature 46, the consumer may track the status of the order details by using Order Details feature 112 and print or email the tracked order transaction by using Print/Email feature 25.

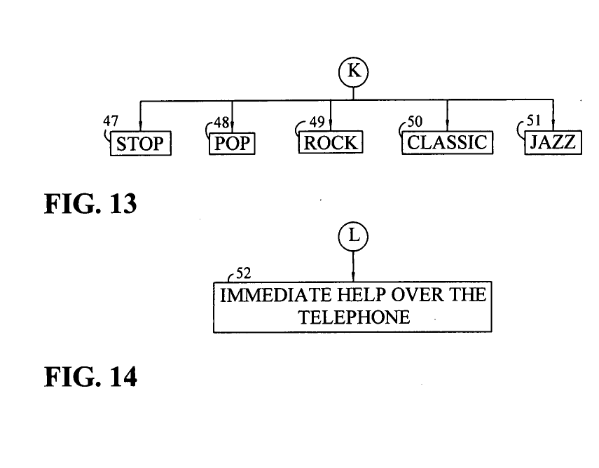

Selecting Music Preference link 15 of Main Menu 4 (FIG. 2) enables the consumer to set music preferences. As shown in FIG. 13, upon selecting Music Preference link 15, the consumer is provided with various options for setting the background music. Stop feature 47 enables the consumer to stop the background music. Pop feature 48 enables the consumer to set the music to pop. Rock feature 49 enables the consumer to set the music to rock. Classic feature 50 enables the consumer to set the music to classic. Jazz feature 51 enables the consumer to set the music to jazz.

Immediate Assistance link 16 of Main Menu 4 (FIG. 2) enables the consumer to get immediate shop assistance while the consumer selects or designs her office furniture layout. As shown in FIG. 14, upon selecting Immediate Assistance link 16, the consumer is provided at 52 with immediate assistance over phone 13 placed at the kiosk. The consumer may desire to get immediate assistance, have a office furniture manufacturer design specialist (“design specialist”) call the consumer later, or make an appointment with the design specialist for a later time. A design specialist is a person trained to assist consumers in selecting and designing the consumer's office furniture according to the consumer's wants and needs. If the consumer wants immediate help, the furniture manufacturer may provide help over a web-enabled microphone. The software of the present invention may also connect the consumer to a design specialist over network 16. Upon the consumer sending her saved file to the design specialist, the specialist may help design the consumer's furniture. In doing so, the consumer may watch the design specialist complete the consumer's office furniture as display 14 (FIG. 1) refreshes.

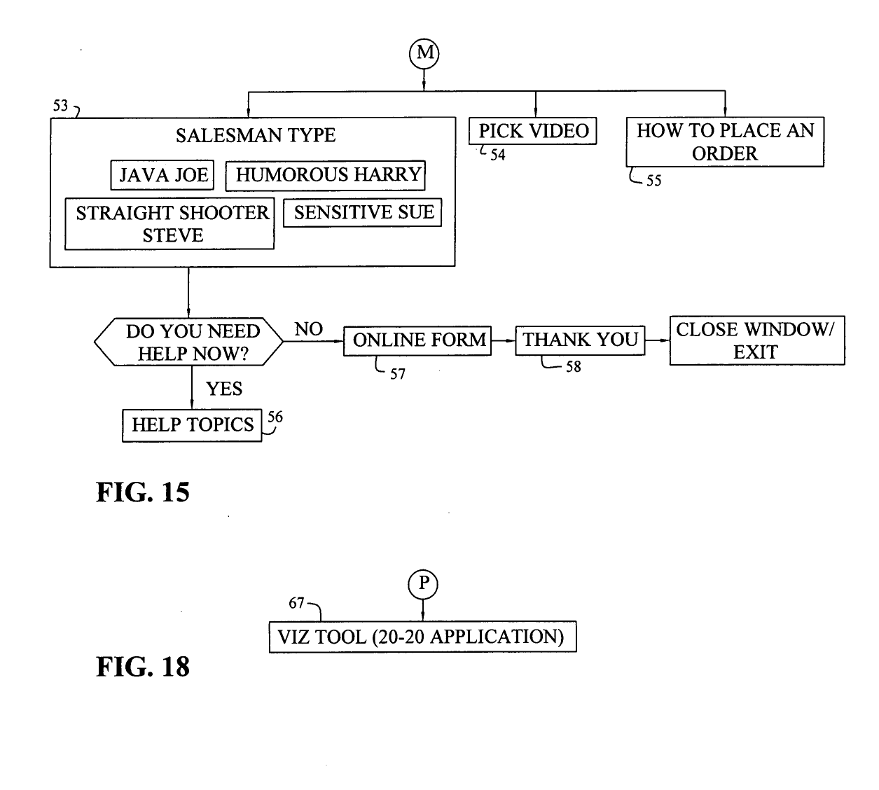

Help link 17 of Main Menu 4 (FIG. 2) enables the consumer to access furniture manufacturer helpdesk 30. As shown in FIG. 15, selecting Help link 17 provides the consumer with access to Salesman Type feature 53, Pick Video feature 54, How to Place an Order feature 55, Help Topics feature 56, Online Form feature 57 and Thank You feature 58. Feature 53 enables the consumer to select a salesperson type based on the consumer's preference. The salesperson types include Java Joe, Humorous Harry, Straight Shooter Steve and Sensitive Sue. Feature 54 enables the consumer to select a video that provides instructions. Feature 55 enables the consumer to select instructions on how to place an order. Feature 56 provides the consumer with a list of help topics. Feature 57 enables the consumer to enter information about the type of assistance and the date on which it is required, and feature 58 displays a thank you message.

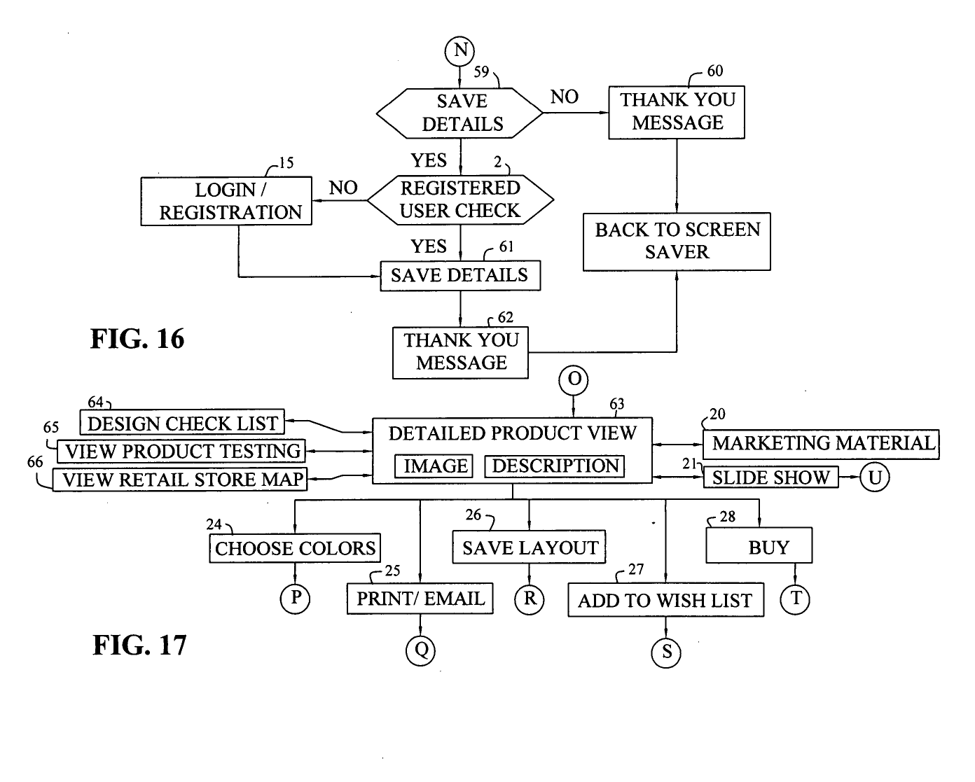

Exit link 18 of FIG. 2 enables the consumer to exit from the software of the present invention. As shown in FIG. 16, upon selecting Exit link 18 the consumer is provided at 59 with the option to save his information, wish list and shopping cart details. Thank You Message feature 60 displays a thank you message when the consumer chooses not to save information at 59. If the consumer wishes to save the information and has not logged into the system or registered, the consumer is provided with the option to do so by using Login/Registration feature 15. After choosing to save his information using Save Details feature 61, the consumer software displays a personalized thank you message using Thank You Message feature 62 before returning the consumer to Screen Saver 1.

Upon exiting the software, the consumer has a few different options based on the consumer's activity within the system. If the consumer purchased any office furniture while using the software, no further action is necessary. If the consumer selected or designed furniture and placed the items on the shopping list or in the shopping cart, then the consumer may later use computer 12, either in retail store 10 or home/office 20, to resume the saved session and order the furniture items. The consumer may also use a saved shopping list as an order form to be faxed or e-mailed to the furniture manufacturer or retail store 10, as well as using the saved shopping list to phone in, send in, or order the furniture items in person in retail store 10.

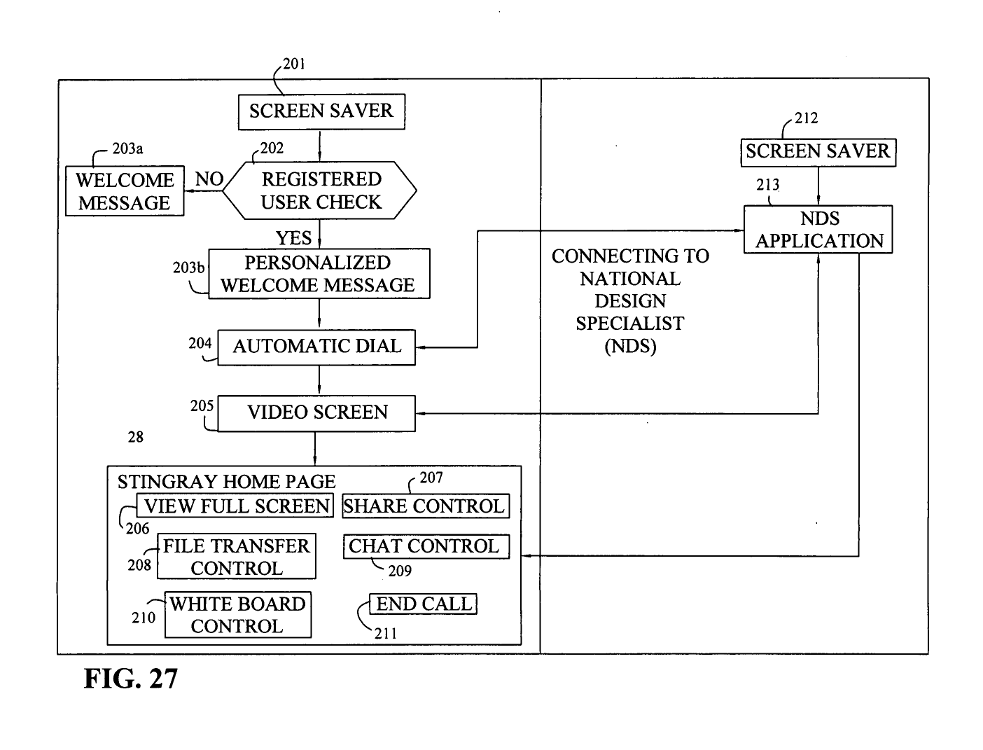

Referring to FIG. 27, the software of the present provides an online connectivity between the consumer's system and the office furniture manufacturer's design specialist. When the consumer accesses the software, the system will check if the consumer is registered with the site and displays a welcome message accordingly. An automatic dialing process is started and the system sends a request to the design specialist to accept the call. On accepting the call, the design specialist's system establishes connection with the consumer and may control the consumer's system provided the consumer enables the control. Both the office furniture manufacturer and the consumer may view the full screen, chat, use the white board, or choose to end the call. This online connectivity is explained in more detail below in reference to FIG. 27.

At 201 the Stingray screen saver provides the consumer and the design specialist a preview of the application. The screen saver displays the office furniture manufacturer's logo and image renderings of individual furniture pieces, open offices and walled offices. A mascot draws the consumer's attention to text that provides an explanation of the images on the welcome screen.

At 202 the system checks on whether the consumer is a registered user and displays a message accordingly.

A welcome message is displayed at 203a. The message is personalized at 203b if the consumer has registered with the software; otherwise, the message is a standard welcome message.

At 204 the consumer's software automatically dials the design specialist's system.

At 205, if the consumer's system has established contact with the furniture's specialist's system, the video screen is displayed on both of the systems, the consumer is able to see the design specialist and the design specialist is able to see the consumer.

At 206 the view full screen feature displays the application along with the minimized video screen.

At 207 the share control allows the design specialist to have control over the consumer's application.

At 208 the file control allows file transfer.

At 209 the chat control allows an on-line chat to be started.

At 210 the white board may be started.

At 211 the call maybe ended.

At 212 the welcome screen saver is displayed on the design specialist's system.

At 213 the software is invoked on the design specialist's system and is ready to accept the consumer's call.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A method of selecting and ordering office furniture components, the method comprising the steps of:
enabling a user to submit user information relating to office furniture requirements and user preferences;
selecting one or more office furniture components customized to the user based on the user information; and
enabling the user to purchase at least one of the customized office furniture components and non-customized office furniture components.

2. The method of claim 1 wherein the selecting step includes a step of determining the user's work style preference.

3. The method of claim 1 wherein the step of enabling a user to submit user information includes a step of enabling the user to choose an individual office furniture component.

4. The method of claim 1 wherein the step of enabling a user to submit user information includes a step of enabling the user to choose the office furniture components based on the user's work style.

5. The method of claim 1 wherein the step of enabling a user to submit user information includes a step of enabling the user to choose the office furniture components based on the user's budget.

6. The method of claim 1 wherein the step of enabling a user to submit user information includes a step of enabling the user to choose the office furniture components based on the user's optimal use of existing office space.

7. The method of claim 1 wherein the step of enabling a user to submit user information includes a step of enabling the user to choose the office furniture components based on the user's accommodation of an additional employee.

8. The method of claim 1 wherein the step of enabling a user to submit user information includes a step of enabling the user to choose the office furniture components for an office to be moved.

9. The method of claim 1 wherein the step of enabling a user to submit user information includes a step of enabling the user to choose the office furniture components for an office to be remodeled.

10. The method of claim 1 wherein the step of enabling a user to submit user information includes a step of enabling the user to choose the office furniture components for the purpose of changing the layout of an office.

11. The method of claim 1 wherein the step of enabling a user to submit user information includes a step of connecting the user to a specialist to assist the user in the selection of the office furniture components.

12. A method of selecting and ordering office furniture components, the method comprising the steps of:
determining the user's work style based on information submitted by the user;
utilizing the user's work style to select one or more office furniture components customized to the user; and
enabling the user to purchase at least one of the customized office furniture components and non-customized office furniture components.

13. The method of claim 12 further including a step of deriving the work style.

14. The method of claim 13 wherein the step of deriving the work style includes a step of conducting market segmentation studies.

15. The method of claim 12 wherein the step of determining includes the steps of:
providing a questionnaire to the user, the questionnaire enabling the user to provide answers to multiple questions;
determining a score based on the answers; and
using the score to determine the user's work style.

16. A system for selecting and ordering office furniture components, the system comprising:
a computer enabling a user to input user information relating to office furniture requirements and the user's preferences; and
a server accessible by said computer over a network, said server storing software capable of performing the steps of:
determining the user's work style based on the inputted user information;
selecting one or more office furniture components customized to the user based on the user's work style; and
enabling the user to purchase the one or more office furniture components customized to the user.

17. The system of claim 16 wherein the network includes a globally accessible information interchange network.

18. The system of claim 16 further comprising a database in communication with said server over the network, said database storing the user information.

19. The system of claim 16 further comprising at least one of a second server associated with the manufacturer of the office furniture components and a third server associated with the supply source of a retailer that sells the office furniture components, said second and third servers in communication with said server accessible by said computer.

20. A method of selecting and ordering office furniture components, the method comprising the steps of:
enabling a user to submit user information relating to office furniture requirements and user preferences from a kiosk within a retail store;
selecting one or more office furniture components customized to the user based on the user information; and
enabling the user to purchase at least one of the customized office furniture components and non-customized office furniture components.
